(19) United States
(12) Patent Application Publication
(10) Pub. No.: US 2023/0034621 A1
(43) Pub. Date: Feb. 2, 2023

(54) MINTING, TRANSFER AND MANAGEMENT OF NON-FUNGIBLE TOKENS IN SETS

(71) Applicant: Rene PARDO, Woodbridge (CA)

(72) Inventor: Rene PARDO, Woodbridge (CA)

(21) Appl. No.: 17/815,528

(22) Filed: Jul. 27, 2022

Related U.S. Application Data
(60) Provisional application No. 63/226,506, filed on Jul. 28, 2021.
(60) Provisional application No. 63/282,531, filed on Nov. 23, 2021.

(51) Int. Cl. G06Q 20/36; H04L 9/32; H04L 9/00

(52) U.S. Cl. CPC G06Q 20/3672; G06Q 20/3674; H04L 9/3213; H04L 9/50; G06Q 2220/00

(57) ABSTRACT

A non-fungible token (NFT) system and NFT method that includes relational or causal data between different NFTs in a set of NFTs. The NFT method includes minting, transferring, burning, or fusing NFTs, into a new NFT based on ownership of particular subset of NFTs in a set of NFTs. The NFT method includes execution of at least one rule or smart contract after minting or transferring of a NFT that relates to another NFT which is already minted or to be minted. The method can include: minting, transferring, burning, or fusing NFTs on a blockchain, using at least one processor, a first NFT having NFT metadata; and executing, using the at least one processor, at least one rule which references the first NFT and at least one other NFT. Other examples of the NFT method are applied to fractional NFTs in a similar fashion.

### CROSS-REFERENCE

This application claims the benefit of priority to U.S. Provisional Patent Application No. 63/226,506 filed Jul. 28, 2021 entitled MINTING, TRANSFER AND MANAGEMENT OF NON-FUNGIBLE TOKENS IN SETS and U.S. Provisional Patent Application No. 63/282,531 filed Nov. 23, 2021 entitled MINTING, TRANSFER AND MANAGEMENT OF NON-FUNGIBLE TOKENS IN SETS, all the entire contents of which are incorporated by reference into the Detailed Description herein below.

### TECHNICAL FIELD

Example embodiments relate to currency tokens such as non-fungible tokens (NFTs), for example the minting, transfer, burning, fusing, and managing of NFTs.

### BACKGROUND

A non-fungible token (NFT) represents a digital asset and is stored on a distributed ledger, typically on a blockchain. Examples of such blockchains include Ethereum™, Flow™, and Tezos™. An NFT can be used to represent unique digital assets. In contrast to cryptocurrency tokens which are fungible, NFTs are unique and not interchangeable. NFTs are typically used to represent digital assets including but not limited to photos, videos, audio, and other types of digital files. NFTs can be used to represent ownership of digital assets in fields including but not limited to art, music, sports, and other popular entertainment. Access to a copy of the original file, however, is typically not restricted to the owner of the NFT. While copies of these digital asset are available for anyone to obtain, NFTs are tracked on blockchains to provide the owner with a proof of ownership that is typically separate from copyright or statutory intellectual property rights. NFTs can be a digital representation of physical goods, if for example those physical products can be scanned.

NFTs may even be used to record on the blockchain other creative forms, means and/or processes including but not limited to software and even documentation of new ideas and identity of their creators, including the NFT being a date and time record of the activity and information.

An NFT can be owned by an entity, typically using a NFT wallet (or generically a crypto wallet). NFTs can be transferred between entities. The transfer of an NFT involves generating an immutable log of the transfer on the blockchain, and the entire chain of title of the NFT can be audited through inspection of the blockchain relating to the NFT.

An arbitrary number of tokens can be generated at a time by a blockchain system. Each token can then be minted into a respective NFT, representing the digital asset. A difficulty with conventional blockchain systems is that the NFTs are typically treated individually once minted, and there is not any relational data or causality between the NFTs.

As well, in some examples, a single NFT may be divided into fractions, such that the fractions themselves may indicate partial ownership of the NFT, and indirectly partial ownership of the item or digital asset represented by the NFT.

It is desired to provide a NFT system that includes relational or causal data between different NFTs in a set of NFTs.

It is desired to provide a NFT system that includes minting, transferring, burning, or fusing (also known as combining or merging) NFTs into, a new NFT based on ownership of particular subset of NFTs in a set of NFTs.

It is desired to provide a NFT system that includes execution of at least one rule after minting, transferring, burning, or fusing NFTs into, a NFT that relates to another NFT which is already minted or to be minted.

Additional difficulties may be appreciated in view of the Detailed Description, herein below.

### SUMMARY

Example embodiments relate to non-fungible tokens (NFTs), for example the minting, transfer, burning, fusing NFTs, and management of NFTs as fractional NFTs or as part of sets of NFTs.

Example embodiments relate to a non-fungible token (NFT) system and NFT method (sometimes generally referred to as method) that includes relational or causal data between different NFTs in a set of NFTs. The NFT method includes minting or transferring of a new NFT based on ownership of particular subset of NFTs in a set of NFTs. The NFT method includes execution of at least one rule or smart contract after minting or transferring of a NFT that relates to another NFT which is already minted or to be minted.

An example embodiment is a method comprising: minting or transferring on a blockchain, using at least one processor, a first non-fungible token (NFT) having NFT metadata; and executing, using the at least one processor, at least one rule which references the first NFT and at least one other NFT.

In an example embodiment of any of the above methods, the at least one rule is executed from a smart contract.

In an example embodiment of any of the above methods, the smart contract is on the blockchain.

In an example embodiment of any of the above methods, the smart contract is on the first NFT.

In an example embodiment of any of the above methods, the smart contract is on at least one of the other NFTs.

In an example embodiment of any of the above methods, the smart contract is on at least one computing device off the blockchain.

In an example embodiment of any of the above methods, the executing the at least one rule includes: second minting, using the at least one processor, a new NFT on the blockchain; and transferring, using the at least one processor, the new NFT on the blockchain to an owner of the first NFT.

In an example embodiment of any of the above methods, the executing including determining that the first NFT and the at least one other NFT are commonly owned by the owner, and in response to the determining, performing the second minting.

In an example embodiment of any of the above methods, the determining includes querying the blockchain to verify that a wallet address of the first NFT belongs to the owner.

In an example embodiment of any of the above methods, the executing the at least one rule includes transferring, using the at least one processor, a new NFT on the blockchain to an owner of the first NFT.

In an example embodiment of any of the above methods, the rule references a respective address on the blockchain of the at least one other NFT.

In an example embodiment of any of the above methods, the rule references a respective NFT name of the at least one other NFT.

In an example embodiment of any of the above methods, the executing including determining that the first NFT and the at least one other NFT satisfy a set of NFTs.

In an example embodiment of any of the above methods, the executing including determining that the first NFT and the at least one other NFT satisfy location criteria.

In an example embodiment of any of the above methods, the executing including determining that the first NFT and the at least one other NFT satisfy sequence criteria.

In an example embodiment of any of the above methods, the sequence criteria is a temporal sequence or a location sequence.

In an example embodiment of any of the above methods, the executing including determining a hierarchy of the first NFT and the at least one other NFT.

In an example embodiment of any of the above methods, the executing includes modifying the NFT metadata.

In an example embodiment of any of the above methods, the modifying includes modifying the NFT metadata to indicate that the rule is satisfied.

In an example embodiment of any of the above methods, the NFT metadata includes a reference to the at least one other NFT.

In an example embodiment of any of the above methods, the NFT metadata includes the at least one rule.

In an example embodiment of any of the above methods, the NFT metadata includes: a NFT title; a NFT type; and/or NFT properties including a NFT name, NFT description, a NFT image uniform resource indicator (URI) which addresses a digital asset, and/or NFT attributes.

In an example embodiment of any of the above methods, the digital asset is an image, a video file, an audio file, a multimedia file, a hologram, a deed, a word, or words.

In an example embodiment of any of the above methods, the NFT metadata includes the at least one rule.

In an example embodiment of any of the above methods, the NFT metadata includes a NFT metadata URI which addresses one or more elements of the NFT metadata.

In an example embodiment of any of the above methods, at least one of the processors is a node.

In an example embodiment of any of the above methods, at least one of the processors is in a computing device off the blockchain.

In an example embodiment of any of the above methods, the computing device stores the at least one rule off the blockchain.

In an example embodiment of any of the above methods, the first NFT is a currency token, a blockchain token, an Ethereum token, an Ethereum Request for Comment 721 (ERC-721) NFT or an Ethereum Request for Comment 1155 (ERC-1155) NFT.

Another example embodiment is a method comprising: minting or transferring on a blockchain, using at least one processor, a first NFT having NFT metadata which references at least one other NFT.

Another example embodiment is a method comprising: minting or transferring on a blockchain, using at least one processor, a first NFT; and second minting or second transferring on the blockchain, as a consequence to the minting or the transferring, using the at least one processor, a second NFT.

Another example embodiment is a method comprising: minting or transferring on a blockchain, using at least one processor, a first NFT to a client device; and second minting or second transferring on the blockchain, as a consequence to the minting or the transferring, using the at least one processor, a blockchain token to the client device.

Another example embodiment is a method comprising: minting or transferring on a blockchain, using at least one processor, a NFT having NFT metadata which includes identification of at least one game element, and executing, using the at least one processor, at least one rule which references the at least one game element of the NFT.

In an example embodiment of any of the above methods, the at least one game element is a game piece.

In an example embodiment of any of the above methods, the at least one game element is a game position.

In an example embodiment of any of the above methods, the NFT metadata includes a reference to at least one other NFT, the at least one other NFT having at least one other NFT metadata which includes identification of at least one other game element.

In an example embodiment of any of the above methods, the rule is satisfied when the at least one game element is a game piece and the at least one other game element is a game position.

In an example embodiment of any of the above methods, the NFT metadata includes the at least one rule.

In an example embodiment of any of the above methods, the at least one rule includes at least one game rule.

In an example embodiment of any of the above methods, the at least one game rule references at least one other NFT.

In an example embodiment of any of the above methods, the at least one game rule references the first NFT and at least one other NFT.

In an example embodiment of any of the above methods, the NFT metadata references at least one other NFT.

Another example embodiment is a method comprising: transferring on a blockchain, using at least one processor, a first fraction of a NFT having NFT metadata; and executing, using the at least one processor, at least one rule which references the first fraction of the NFT and a second fraction of the NFT.

Another example embodiment is a method comprising: transferring on a blockchain, using at least one processor, a first fraction of a NFT having NFT metadata which references at least one other fraction of the NFT.

Another example embodiment is a method comprising: receiving on a blockchain, using at least one processor, a first NFT having NFT metadata; and executing, using the at least one processor, at least one rule which references at least one other NFT.

In an example embodiment of any of the above methods, the method further includes receiving on the blockchain, using the at least one processor, a newly minted NFT as a consequence to the executing the at least one rule.

Another example embodiment is a method comprising: receiving on a blockchain, using at least one processor, a first NFT having NFT metadata which references at least one other NFT.

Another example embodiment is a NFT system comprising: at least one processor configured to perform any of the above methods.

Another example embodiment is a non-transitory memory containing instructions which, when executed by one or more processors, cause the one or more processors to perform any of the above methods.

An advantage and technical effect is that the method executes one or more rules based on ownership of NFTs, in which the NFT are a set of NFTs, therefore relating the NFTs.

An advantage and technical effect is that a new NFT can be minted and/or transferred when the rule is satisfied, therefore trigging automatic minting and/or transferring of new NFTs which can increase the number and value of NFTs.

An advantage and technical effect is that the method can be applied to a game, therefore increasing NFT activity, the minting and/or transferring of new NFTs, and distribution of prizes based on familiar or new games implemented by the method.

### BRIEF DESCRIPTION OF THE DRAWINGS

Reference will now be made, by way of example, to the accompanying drawings which show example embodiments, and in which:

FIG. 1 illustrates in diagrammatic form a NFT system and NFT method, in accordance with an example embodiment;

FIG. 2 illustrates in diagrammatic form a client device of the NFT system of FIG. 1, in accordance with an example embodiment;

FIG. 3 illustrates in diagrammatic form a node of the NFT system of FIG. 1, in accordance with an example embodiment;

FIG. 4 illustrates a detailed example of NFT metadata for the NFT system of FIG. 1, in accordance with an example embodiment;

FIG. 5 illustrates a detailed example communication flow diagram of the NFT method in FIG. 1, in accordance with an example embodiment;

FIG. 6 illustrates in diagrammatic form another example NFT system and NFT method, in accordance with another example embodiment;

FIG. 7 illustrates in diagrammatic form a rules manager device of the NFT system of FIG. 6, in accordance with an example embodiment;

FIG. 8 illustrates a detailed example communication flow diagram of the NFT method in FIG. 6, in accordance with an example embodiment;

FIG. 9 illustrates a detailed example of a NFT transfer over a blockchain for the NFT method, in accordance with an example embodiment;

FIG. 10 illustrates another detailed example of the NFT method as performed by the NFT system, in accordance with an example embodiment;

FIG. 11 illustrates another detailed example of the NFT method as performed by the client device, in accordance with an example embodiment;

FIG. 12 illustrates an example of the NFT method as applied to a tic tac toe game; and

FIG. 13 illustrates an example of the NFT method as applied to a bingo game.

Similar reference numerals may have been used in different figures to denote similar components.

### DETAILED DESCRIPTION

Example embodiments relate to non-fungible tokens (NFTs), for example the minting, transfer and management of NFTS as part of sets of NFTs.

A non-fungible token (NFT) system and NFT method that includes relational or causal data between different NFTs in a set of NFTs. The NFT method includes minting or transferring of a new NFT based on ownership of particular subset of NFTs in a set of NFTs. The NFT method includes execution of at least one rule or smart contract after minting or transferring of a NFT that relates to another NFT which is already minted or to be minted.

An example embodiment is a method comprising: minting or transferring on a blockchain, using at least one processor, a first non-fungible token (NFT) having NFT metadata; and executing, using the at least one processor, at least one rule which references the first NFT and at least one other NFT.

Another example embodiment is a method comprising: minting or transferring on a blockchain, using at least one processor, a first NFT having NFT metadata which references at least one other NFT.

Another example embodiment is a method comprising: minting or transferring on a blockchain, using at least one processor, a first NFT; and second minting or second transferring on the blockchain, as a consequence to the minting or the transferring, using the at least one processor, a second NFT.

Another example embodiment is a method comprising: minting or transferring on the blockchain, using at least one processor, a first NFT to a client device; and second minting or second transferring on the blockchain, as a consequence to the minting or the transferring, using the at least one processor, a blockchain token to the client device.

Another example embodiment is a method comprising: minting or transferring on a blockchain, using at least one processor, a NFT having NFT metadata which includes identification of at least one game element, and executing, using the at least one processor, at least one rule which references the at least one game element of the NFT.

Another example embodiment is a method comprising: transferring on a blockchain, using at least one processor, a first fraction of a NFT having NFT metadata; and executing, using the at least one processor, at least one rule which references the first fraction of the NFT and a second fraction of the NFT.

Another example embodiment is a method comprising: transferring on a blockchain, using at least one processor, a first fraction of a NFT having NFT metadata which references at least one other fraction of the NFT.

Another example embodiment is a method comprising: receiving on a blockchain, using at least one processor, a first NFT having NFT metadata; and executing, using the at least one processor, at least one rule which references at least one other NFT.

Another example embodiment is a method comprising: receiving on a blockchain, using at least one processor, a first NFT having NFT metadata which references at least one other NFT.

Another example embodiment is a NFT system comprising: at least one processor configured to perform any of the methods and NFT methods described herein.

Another example embodiment is a non-transitory memory containing instructions which, when executed by one or more processors, cause the one or more processors to perform any of the methods and NFT methods described herein.

Blockchain is a distributed database that is kept synchronized across all the participating nodes by implementation specific protocols. The blockchain holds a list of transactions, and optionally other information such as administrative information. The blockchain is also used to perform and authenticate the transactions.

Blockchain is often compared with a bank ledger that holds the transaction information. However, there is a subtle difference. A bank account holds current balance as a part of the database, whereas a blockchain database may hold only transactions with information such as “from” account, “to” account, and “value” of the transaction, etc. Nodes (miners or sealers) validate a transaction by walking down the blockchain to verify whether the said “from” account has sufficient balance required for the transaction from all previous transactions involving the account.

The term “token” or “currency token” is used in many contexts in the domain of blockchain and crypto-currencies. The token may represent the “value” that is transferred from one account to the other in the context of a transaction, and the token may represent an account on the blockchain itself (with an associated private key) that “contains” the value of the token when token is “purchased” or transferred from an exchange (buying tokens).

It may be useful to think of a token as a “value representation”. In the domain of blockchain, all values are recorded in the blockchain database in the form of immutable blocks of information. So, possessing a token simply implies the ownership of the private key for the account on the blockchain that represents the value of the token. Only the ownership of the private key of any account enables the transaction that involves value transfer from that account to some other account.

Ethereum™ is a platform designed for decentralized applications over the blockchain. Ethereum uses blockchain technology to produce currency tokens (also referred to as tokens or coins), and also allow for smart contracts to be distributed securely on the blockchain network. It is the blockchain database that secures the transactions. These smart contracts are computer programs coded with functions that can be located on an address in the blockchain network. The smart contracts are secure and immutable and allow for data and information exchanges.

In example embodiments, the protocols of blockchain, including Ethereum, can be used in NFT systems and NFT methods to mint, transfer, and manage NFTs. NFTs are unique and therefore not interchangeable. An NFT certifies ownership of a digital asset. Examples of Ethereum protocols that implement NFTs include Ethereum Request for Comment 721 (ERC-721) and Ethereum Request for Comment 1155 (ERC-1155). Generally, ERC-20 require deployment of separate contracts per token type. The ERC-721 standard can be used to define a token ID as a single non-fungible index in which a group of NFTs are deployed as a single contract with settings for the entire collection. In contrast, the ERC-1155 Multi Token Standard allows for each token ID to represent a new configurable token type, which may have its own metadata, supply and other attributes. ERC-1155 supports a mixture of both fungible and non-fungible tokens in a collection of NFTs.

Example embodiments relate to executing one or more rules based on ownership of NFTs, in which the NFT are a set of NFTs. In an example embodiment, a rule is executed when a client device receives an NFT. For example, the rule can be a condition, for example a relation between the NFT and another NFT. The execution of the rule can include minting a new NFT when the rule is satisfied, or the transfer of a pre-existing NFT that has already been minted.

Example embodiments of the NFT method can relate to a scenario in the set of NFTs is part of a game. The NFTs can each relate to a game element. One or more rules are executed when ownership of the NFTs satisfies the particular rule. For example, a new NFT can be minted to an owner of a client device as a consequence to ownership of two or more of the NFTs satisfying a particular game rule. The game element can be from a classical game (e.g. tic tac to, bingo, lottery) or as a new game.

Games typically have rules of procedures and conditions for being declared the winner of the game, or a winner of a part of the game. For example, in an example scenario, the set of NFTs relate to the game of tic tac toe. The game includes a 3×3 grid. Each grid location is a game element. In the conventional game, two players takes turns playing a respective game element (game piece) on the grid, for example X or O. The goal is for one player to have three consecutive grid locations of their game piece (row, column, or diagonal). When a player has three consecutive grid locations, that player is indicated as winning the game. In an example of the NFT method, each of the nine grid locations can be a respective NFT purchased by a user, for example top-left, top-middle, top-right (first row), left, middle, right (middle row), bottom-left, bottom-middle, bottom-right (bottom row). A player which owns three NFTs that represent the consecutive grid locations (row, column, or diagonal) can be indicated as having won. The indication can be made in a server or in metadata on the blockchain, for example. In an example, a new NFT can be minted to the player owns three consecutive grid locations of the NFTs, which indicates a win condition based on ownership of a subset of the NFTs.

In another example scenario, the set of NFTs relate to the game of bingo. The game includes a 5×5 grid. In some examples, each grid location is a game element. In the conventional game, numbers are drawn and are associated with a letter: e.g. “B” (numbers 1-15), “I” (numbers 16-30), “N” (numbers 31-45), “G” (numbers 46-60), and “0” (numbers 61-75). Each number (associated with a letter) is a game element that can be owned as an NFT. In the conventional game, the goal is to have five consecutive grid locations (row, column or diagonal). When a player has five consecutive grid locations, that player is indicated as winning the game. In other examples, there are other variants of win conditions for bingo, such as “four corners”, “whole card”, “cross-shape”, “X-shape”, etc.

In an example of the NFT method, a player can own (purchase) at least one of the 75 numbers (each associated with a letter). In an example, a particular bingo card can be revealed. If a player owns the numbers on the bingo card that satisfy a particular rule for a win condition, such as five consecutive grid locations, that player is be indicated as having won. The indication can be made in a server or in metadata on the blockchain, for example. In an example, a new NFT can be minted that indicates that the player owns five of the NFTs consecutive grid locations, which indicates that the player has won. A smart contract can also be used to transfer a prize to the owner. The prize can be money, a media file, a cryptocurrency, etc. The prize can be pooled from players in the game. The prize can be obtained by garnishing from the various NFT transactions related to the bingo game. The prize can be sponsored by an advertiser.

In an example, if no user owns the particular NFTs to satisfy the win rule in the bingo game, then users can purchase NFTs until the win condition is satisfied.

In another example scenario, the set of NFTs relate to a lottery game. In conventional lottery games, a set number of numbers are drawn from a larger set. For example, 10 numbers are drawn from a set of 100 numbers. In conventional lottery games, a player who matches some or all of the 10 numbers may be considered a winner.

In an example of the lottery game, each number is a game element that can be owned as an NFT. In the conventional game, the goal is to match some or all of the drawn numbers. In an example of the NFT method, a player can own (purchase) at least one of the 100 numbers. A particular set of drawn numbers can be revealed, e.g. 10 numbers. If a player owns the lottery numbers that satisfy a particular rule for a win condition, such as all or a set number of the drawn numbers, that player is be indicated as having won that particular win condition. The indication can be made in a server or in metadata on the blockchain, for example. In an example, a new NFT can be minted that indicates that the player owns the particular win condition, for example all 10 numbers or a particular subset (e.g. 5 numbers). A smart contract can also be used to transfer a prize to the owner. Examples of prizes include but are not limited to: The prize can be money, a media file, a cryptocurrency, etc. The prize can be pooled from players in the game. The prize can be obtained by garnishing from the various NFT transactions related to the lottery game. The prize can be sponsored by an advertiser.

In an example, if no user owns the particular NFTs to satisfy the win rule in the lottery game, then users can purchase NFTs (or fractions thereof depending on the rules) until the win condition is satisfied.

In another example, the game is a chess game. A player can own a particular game element (chess piece or chess position on an 8×8 board). A particular rule can be executed when the player owns the NFTs associated with game elements that satisfy the rule. A new NFT can be minted when the player owns a particular subset of the NFTs, for example check-mate, castling, bishop pairs, etc.

In another example, the game is a card game, such as poker. A player can own a particular game element, such as one of the 52 playing cards (and optionally 1-2 jokers). A particular rule can be executed when the player owns the NFTs associated with game elements that satisfy the rule. A new NFT can be minted when the player owns a particular subset of the NFTs, for example Royal Flush, 4 of a kind, straight, flush, etc. A new NFT can be minted when the player owns, for example “all four Aces”. In an example, there is a rule such that even though a player has received a particular playing card, e.g. the Ace of Spades, the new NFT pertaining to “all four Aces” does not transfer to the player unless the player satisfy other rules, such as owning all four NFTS representing the four Aces.

In another example embodiment, the NFTs are a set of digital assets which are related. For example, the digital asset can include but not be limited to digital images, videos, audios, etc. A user who owns more than one of the digital assets may satisfy a particular rule. An NFT can be newly minted when the user satisfies a particular rule and owns a particular subset of NFTs. In other examples, the NFTs represent physical art or physical collectibles, which are represented digitally.

In another example embodiment, the NFTs are digital keys in a set. When a user owns more than one key that satisfies a particular rule, the rule executes in a manner that the user can open a lock (physical or digital). In an example, a new key is minted to the user which represents a new key that can be used to open the lock.

In some examples, a single NFT may be divided into fractions, such that the fractions themselves may indicate partial ownership of the NFT, and indirectly partial ownership of the item or digital asset represented by the NFT. Even though some of the examples refer to NFTs in as single entities, the NFT methods can similarly apply to fractions of NFTs and interrelationships between rules and fractions of NFTs and corresponding triggers of activities defined by the rules.

When an NFT is fractionalized, the NFT is first locked in a smart contract. That smart contract then splits the ERC-721 token into multiple fractions in the form of ERC-20 tokens. Each fraction represents partial ownership of the NFT. Shareholders will possess a fraction of the NFT, equal to the value of their ERC-20 tokens divided by the total number of those tokens produced when the NFT was locked in the smart contract. In an example, each fraction is fungible. In other examples, each fraction is non-fungible.

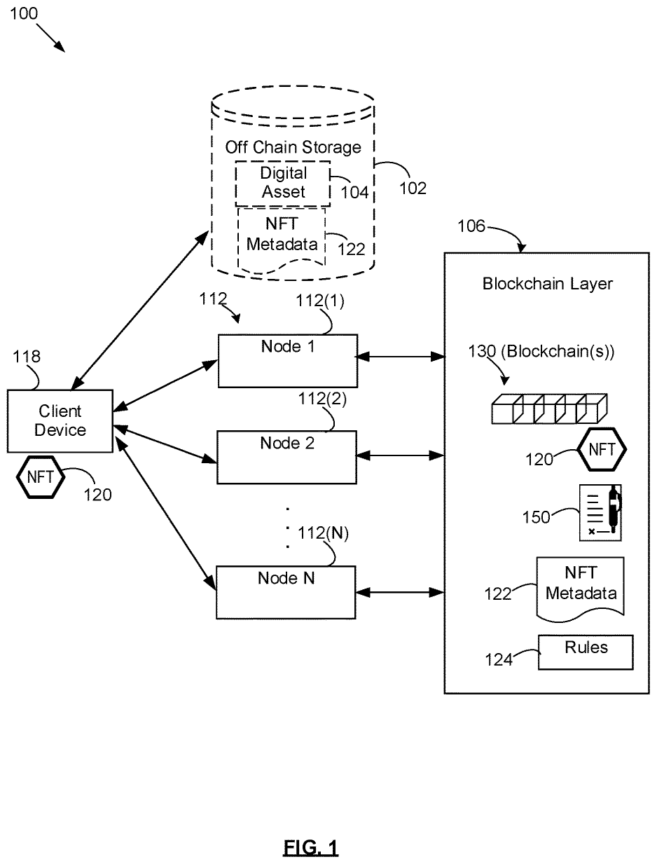

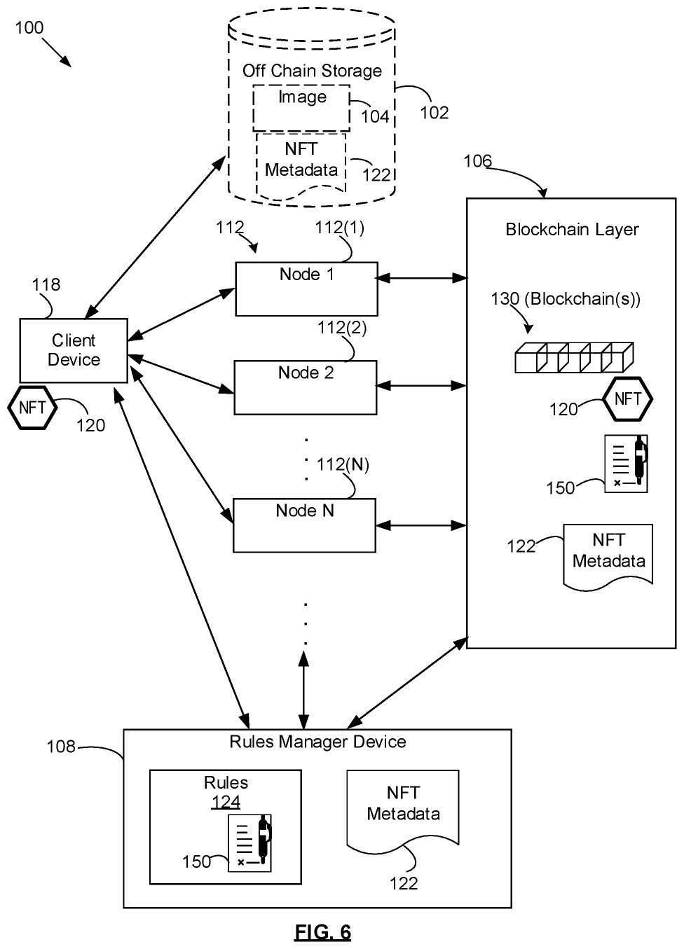

FIG. 1 illustrates a detailed example of the NFT system 100 and NFT method, in accordance with an example embodiment. FIG. 6 illustrates another detailed example of the NFT system 100 and NFT method, in accordance with another example embodiment. The NFT system 100 in FIG. 1 relates to the processing, steps, and rules of the NFT method primarily being executed by the nodes 112 on the blockchain. In examples, a rule can have a condition as well as the steps to be automatically performed or executed when the condition is satisfied. In contrast, the NFT system 100 in FIG. 6 relates to the processing, steps, and rules of the NFT method being performed by the nodes 112 on the blockchain 130 as well as a rules manager device 108 off the blockchain 130. It can be appreciated that various examples can include some aspects of the processing, steps, and rules of the NFT method being performed in various combinations and sub combinations of on and off the blockchain 130.

Referring to FIG. 1, the NFT system 100 includes at least one client device 118 (one shown). The client device 118 is able to store at least one NFT 120 (one shown). The NFT system 100 includes at least one node (each or collectively 112), shown as node 1 (112(1)), node 2 (112(2)), . . . , and node N (112(N)). The NFT system 100 includes a blockchain layer 106.

The blockchain layer 106 can include one or more blockchains 130 which contain the NFTs 120, smart contracts 150, and NFT metadata 122. The nodes 112 can execute transactions on the blockchain 130, to transfer the NFTs 120. The NFTs 120 can be currency tokens, blockchain tokens, Ethereum tokens, ERC-721 NFTs or ERC-1155 NFTs. In an example, a particular NFT 120 can be further split into fractional NFTs. In the example illustrated in FIG. 1, each blockchain 130 can contain at least one rule 124. In examples, the rules 124 can be contained in the smart contracts 150, can be contained in the NFT metadata 122, or can be stand alone information on the blockchain 130. The rules 124 can reference more than one NFT 120, and can contain relational or causal information that is executed in relation to more than one NFT 120. In an example, a rule 124 can relate to minting a new NFT 120 when the rule 124 is satisfied.

In some examples, the NFT system 100 includes off-chain storage 102, which can be a database, server, cloud server, computing device, etc. In an example, the off-chain storage 102 stores at least one digital asset 104, each digital asset 104 being secured by an NFT 120. Optionally, the off-chain storage 102 can include off-chain NFT metadata 122 that can be referenced by an NFT 120 using an NFT metadata uniform resource indicator (URI). Examples of the digital asset 104 include an image, a video file, an audio file, a multimedia file, alpha-numeric file, a hologram, a deed, a word, or words. In some examples, the digital asset is immutable. In some examples, the digital asset is editable. In other examples, there is no off-chain storage 102 and the digital asset 104 and the NFT metadata 122 are stored in the blockchain layer 106.

In an example, the off-chain storage 102 is the InterPlanetary File System (IPFS), which can securely store the digital asset 104 and the NFT metadata 122.

In some examples, any one of the nodes 112 can generate a token that is a root token, and the root token can be used to generate the first block in one of the blockchains. In other examples, tokens are already generated by other parties, and are available for minting. Each token can be minted by the node 112 as an NFT 120 in order to represent a digital asset 104. In examples, the minting of the NFT 120 also includes adding NFT metadata 122 to the NFT 120. The minted NFT 120 has a blockchain address on the blockchain, which represents where to find the NFT 120.

Any one of the nodes 112 can be configured to transfer an NFT 120. In an example, upon successful transfer of an NFT 120, the node 112 adds a block to the blockchain at issue. The added block is an immutable entry on the blockchain and indicates that the NFT 120 was successfully transferred. In some examples, the block contains other data such as the wallet address of the new owner. In some examples, the block contains NFT metadata 122. In some examples, the NFT metadata 122 is modified in response to the successful transfer, in accordance with rules or a smart contract 150.

In some examples, any one of the nodes 112 can be configured to burn a NFT. In examples, burning a NFT can be akin to deleting or destroying the NFT on the blockchain. In some examples, burned NFTs are sent to a verifiably un-spendable address, ultimately eliminating the NFT from the blockchain. In some examples, transactions leading up to the burn will remain on the blockchain ledger.

The burning of a NFT can be accomplished in a variety of ways in various examples. The aim is to reduce the number of tokens that are currently available. In some examples, the burned NFT is not actually destroyed; rather, the burned NFT is rendered unusable in the future. One of the most common way is to send the NFTs to a so-called eater address or null address. The NFTs sent to a null address are considered unusable since the transaction is irreversible. In an example, once the tokens are burned a Proof of Burn or PoB is created. The act of burning a NFT is typically considered a transaction, therefore a transaction (gas) fee is often required to burn the NFT.

In some examples, a fraction of an NFT is burned.

In some examples, any one of the nodes 112 can be configured to fuse (also known as combine or merge) two or more original (pre-fused) NFTs into one new NFT. For example, a new NFT is minted, and the original NFTs are burned. The new NFT is typically a child of the original NFTs. For example, the new NFT can be a concatenation, mathematical combination, mathematical averaging, mathematical formula, etc., of the original NFTs. For example, the new NFT is a new image generated from the original images of the NFTs. For example, in an example scenario where the original NFTs are blue and red, the new NFT can be purple. In some examples, the newly fused NFT has no visual or mathematical relationship to the original NFTs, and is simply a new NFT that is a fusion of the original NFTs.

In some other examples, the new NFT is a child (e.g. child image) of the original NFTs, and the original NFTS are not burned but rather remain in circulation on the blockchain 130.

In some examples, original fractional NFTs are fused into a new NFT, whether those fractional NFTs were from the same original whole NFT or from different whole NFTs.

In some examples, an identical copy of the blockchain 130 is stored amongst the nodes 112. Similarly, an identical copy of the NFTs 120, the smart contracts 150, the NFT metadata 122, and the rules 124 can be stored amongst all of the nodes 112. In some examples, the blockchain 130 and related information is stored on other devices or other nodes (not shown here).

In an example, the client device 118 receives a NFT 120 on the blockchain by receiving and storing a private key associated with the NFT 120 in a wallet of the client device 118, having at least one wallet address. At the same time, in some examples, the client device 118 can also receive a public key associated with the private key. At the same time, in some examples, the client device 118 can also generate or has a passcode associated with the private key. At the same time, in some examples, the client device 118 can also advise of the wallet address to be noted on the blockchain.

In an example, after presentation of the NFT 120 to the node 112 for a transaction, at least one node 112 authenticates the NFT 120 for the transaction using the smart contract 150 and the blockchain 130 of the blockchain layer 106. After the authentication and transfer is completed, an immutable entry is made by the node 112 on the blockchain 130 in the form of a transaction, and the NFT 120 is transferred to the new owner, e.g., a second client device 118 having a second wallet address. The second client device 118 is given a new private key which represents the new block on the blockchain 130. The nodes 112 or another computing device can execute one or more of the rules 124 after successful transfer of the NFT 120.

An example embodiment of the NFT method includes at least one node 112 minting or transferring on the blockchain 130 a first NFT 120 having NFT metadata 122. The first NFT 120 is minted or transferred to the client device 118. The NFT method includes executing, using the at least one node 112, at least one rule 124 which references the first NFT and 120 at least one other NFT 120.

In an example, the executing of the rule 124 includes minting, using at least one node 112, a new NFT 120 on the blockchain 130, and transferring, using the at least one node 112, the new NFT 120 on the blockchain 130 to the client device 118 (which is the same owner as the first NFT 120).

For example, the rule 124 can include the node 112 determining that the first NFT 120 and the at least one other NFT are commonly owned by the client device 118, and in response to the determining, performing the minting of the new NFT 120.

In other examples, the execution of the rule 124 can include the node 112 transferring a second NFT 120 (an already minted NFT 120) to the client device 118. In other examples, the execution of the rule 124 can include the node 112 transferring a token on the blockchain (newly or already generated) to the client device 118.

In an example, the node 112 can determine the ownership of the first NFT 120 by querying the blockchain 130 to verify that the wallet address of the first NFT 120 matches the wallet address of the client device 118.

In an example, the rule 124 references a respective address on the blockchain 130 of the at least one other NFT 120. In an example, the rule 124 references a respective NFT name of the at least one other NFT 120.

In an example, the rule 124 includes determining that the first NFT 120 and the at least one other NFT 120 satisfy a set of NFTs 120. For example, the client device 118 can own a certain subset of the set of NFTs 120 that triggers execution of the rule 124. For example, the client device 118 can own all of the set of NFTs 120 which triggers execution of the rule 124.

In an example, the rule 124 includes determining that the first NFT 120 and the at least one other NFT 120 satisfy location criteria. In another example, the rule 124 includes determining that the first NFT 120 and the at least one other NFT 120 satisfy sequence criteria. For example, the sequence criteria is a temporal sequence, e.g. the NFTs 120 are obtained in a certain temporal order, or represent different temporal states. In another example, the sequence criteria is a location sequence, such as representing a physical or geographic location and a particular sequence of the location. The geographic location can be determined using a Global Positioning System (GPS) of the client device 118, for example the NFT 120 for a geographic landmark is obtained while the client device 118 is located at that geographic landmark.

In another example, the rule 124 includes determining a hierarchy of the first NFT 120 and the at least one other NFT 120. For example, the first NFT 120 owned by the client device 118 has the highest hierarchy, and the rule 124 or minting of a new NFT 120 is executed in response.

In an example, the rule 124 includes the node 112 modifying the NFT metadata 122. In an example, the NFT metadata 122 is modified to reference at least one of the further NFTs 120 (for example, which are also owned by the client device 118) or modified to reference the new NFT 120 (which is now owned by the client device 118). Similarly, the NFT metadata 112 of the new NFT 120 scan include a reference to the first NFT 120. In another example, the NFT metadata 122 of the first NFT 120 is modified to indicate that a rule 124 is satisfied or was executed.

In an example, the NFT method is continuously and repeatedly performed by the NFT system 100 of FIG. 1. In examples, the NFT method can be performed in parallel by the nodes 112 with other users and their respective client device 118.

In some alternate examples, rather than any or all steps that include NFT minting or transferring, the NFT method instead performs NFT burning or NFT fusing.

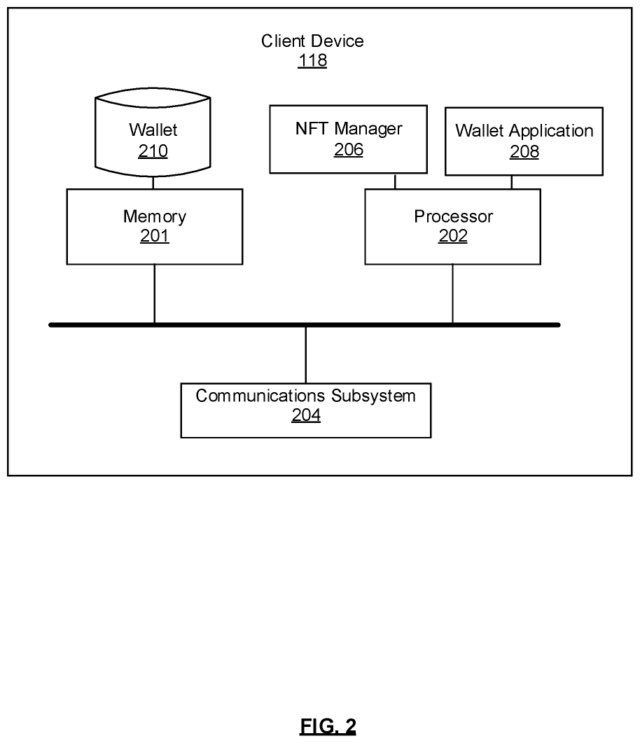

FIG. 2 illustrates a detailed block diagram of the client device 118, according to an example embodiment. The example client device 118 includes a memory 201, a processor 202, and a communications subsystem 204. A communication connection is implemented between the memory 201, the processor 202, and the communications subsystem 204, for example using a bus. The processor 202 is configured to perform, when the program stored in the memory 201 is executed by the processor 202, steps of the NFT method (e.g. as detailed in FIGS. 1 and 6).

In an example, the client device 118 is a communication device. In examples, the client device 118 can be a mobile phone, laptop, tablet, or desktop computer. In examples, the client device 118 can be the processor 302 that executes the described software and functions of the client device 118.

The memory 201 can be a read-only memory (Read Only Memory, ROM), a static storage device, a dynamic storage device, or a random access memory (Random Access Memory, RAM). The memory 201 may store a program. The memory 201 can be a non-transitory memory. The memory 201 can be external or removable in some examples. In an example, the memory 201 includes a wallet 210. The wallet stores one or more wallet addresses of the client device 210. The wallet 210 can also store additional information associated with blockchain transactions, such as private keys, public keys, passcodes, etc.

In examples, the client device 118 includes a NFT manager 206 and a wallet application 208. The wallet application 208 manages the wallet 210, including performing transactions over the blockchain 130 and communicating with the nodes 112. The wallet application 208 also manages user passcodes in order to access the wallet 210. The NFT manager 206 manages NFT functions, which can include activities that interact on the blockchain or off the blockchain. The NFT manager 206 can also interact with the user through a user interface of the client device 118 (not shown here). For example, the NFT manager 206 can be used locate and access the digital asset URI to retrieve the digital asset 104 (e.g. image file) and display on the client device 118 to the user. In some examples, the memory 201 also stores a copy of the NFT metadata 122 and the rules 124 (FIG. 1), for convenient reference by the NFT manager 206.

The wallet 530 includes wallet private keys and wallet public keys. Each wallet private key corresponding to a wallet public key. The wallet private keys are kept secret with the client device 118. The client device 118 can access and transfer the NFTs 120 by using the wallet private key in the form of transactions on the blockchain. The wallet 530 includes the blockchain address of the NFTs 120 on the blockchain layer that are owned by the client device 118. The client device 118 can have other user passwords and security features to protect the wallet private keys, which are understood in the art and not described here. In an example, the wallet application 210 is used by the client device 118 to present a NFT 120 to the node 112. In an example, the client device 118 presents the NFT 120 by using a wallet private key and starting a transaction on the blockchain. In some alternate examples, the wallet 530 is stored externally to the client device 118, such as in a USB drive, another computing device, or on a cloud server (not shown here).

The client device 118 can include user interface devices for user input and user output, not shown. The processor 202 can execute other applications particular to the client device 118, which can include software applications contained in the memory 201, not shown.

The processor 202 can be a general central processing unit (CPU), a microprocessor, an application-specific integrated circuit (ASIC), a graphics processing unit (GPU), or one or more integrated circuits. The processor 202 may be an integrated circuit chip with a signal processing capability. In an implementation process, steps of the NFT method as described herein can be performed by an integrated logical circuit in a form of hardware or by an instruction in a form of software in the processor 202. In addition, the processor 202 can be a general purpose processor, a digital signal processor (DSP), an ASIC, a field programmable gate array (FPGA) or another programmable logic device, a discrete gate or a transistor logic device, or a discrete hardware assembly. The processor 202 can implement or execute the methods, steps, and logical block diagrams that are described in example embodiments. The general purpose processor can be a microprocessor, or the processor may be any conventional processor or the like. The steps of the NFT method disclosed with reference to the example embodiments may be directly performed by a hardware decoding processor, or may be performed by using a combination of hardware in the decoding processor and a software module. The software module may be located in a mature storage medium in the art, such as a random access memory, a flash memory, a read-only memory, a programmable read-only memory, an electrically erasable programmable memory, or a register. The storage medium is located in the memory 201. The processor 202 reads information from the memory 201, and completes, by using hardware in the processor 202, the steps of the NFT method.

The communications subsystem 202 implements communication between the client device 118 and the router 110, and other devices on the local network. In some examples, the communications subsystem can include a transceiver apparatus (including a transceiver) for wireless communication. In some examples, the communications subsystem 202 is configured with wired communication.

It should be noted that, although the memory 201, the processor 202, and the communications subsystem 204 are shown in the client device 118 in FIG. 2, in a specific example implementation, a person skilled in the art should understand that the client device 118 may further include other components that are necessary for implementing execution of the NFT method. In addition, based on specific needs, a person skilled in the art should understand that the client device 118 may further include hardware components that implement other additional functions. In addition, a person skilled in the art should understand that the client device 118 may include only a component required for implementing the embodiments, without a need to include all the components shown in FIG. 2.

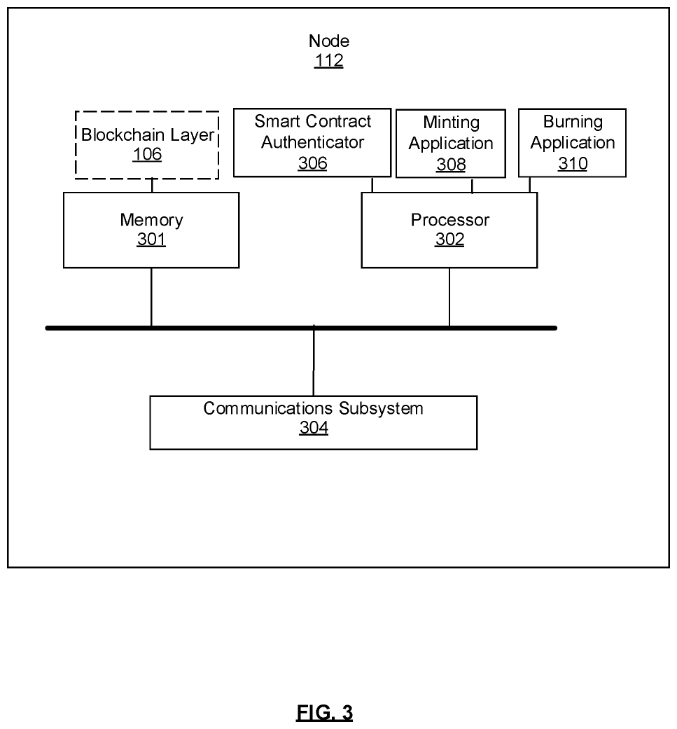

FIG. 3 illustrates a block diagram of a node 112, according to an example embodiment. In an example, the node 112 is a participant of the blockchain 130. In an example, any one of the nodes 112 (e.g. FIG. 1) can be the gateway to which a NFT 120 is presented and authenticated for transferring to a client device 118, after which the node 112 can execute one or more of the rules 124. The node 112 can include a memory 301, a processor 302, and a communications subsystem 302 which in examples can be similar to those described in relation to the client device 118 (FIG. 2). In some examples, a plurality of the nodes 112 perform the authentication of the NFT 120 until a consensus of the nodes 112 is reached which validates the transfer of the NFT 120. The processor 302 can be configured to execute a smart contract authenticator 306, a minting application 308, and a burning application 310.

In some examples, the memory 301 of the node 112 stores a copy of the blockchain layer 106. In some examples, a plurality of the nodes 112 store a copy of the blockchain 130 (FIG. 1), optionally along with other computing devices. In some examples, other computing devices store the blockchain 130, and not the node 112 at issue which is used for performing or authenticating a transaction. The node 112 (along with other nodes 112) can also store an identical copy of the NFTs 120, the NFT metadata 122, the smart contracts 150 and the rules 124 (FIG. 1).

In some examples, one or more of the nodes 112 can create a blockchain by first creating a genesis block (first block) of the blockchain. For example, the node 112 creates a private key, which can be randomly generated or as a solution to a mathematical problem. The node 112 generates a token from the private key, for example by hashing the private key. The node 112 creates a blank database along with a master account that contains a large or inexhaustible amount of such tokens (e.g., very large number of tokens). The master account can initially include a first transaction that has no “from” account and a particular “to” account as a part of the genesis block (first block). The “From” account in any transaction can be blank only in the genesis block. In some examples, there is no creation of new tokens in the set of NFTs 120 subsequent to the genesis block as a result of mining. In such an example, all subsequent token transfers that occur are a result of tokens being transferred from the master account in some form or the other. In other examples, tokens are generated by other nodes, or are pre-generated from other parties and purchased from a token platform such as Ethereum, for example using gas such as Ether (ETH).

The minting application 308 of the node 112 can be configured to mint a token into an NFT 120. The minting can include transferring the NFT 120 on the blockchain to the client device 118. The minting can include tying the NFT 120 to the digital asset 104. The minting can include generating the NFT metadata 122 for the NFT 120. The minting can include generating one or more of the rules 124 for the NFT 120 or set of NFTs 120. The minting can include generating the smart contract 150 for the NFT 120.

In an example, the minting is performed on demand when the client device 118 is the first owner of the NFT 120, with the wallet address of the client device 118 in the “to” account. In another example, the minting is performed in advance, and stored to a different trusted party as the first owner in the “to” account, such as one of the nodes 112, another computing device, or the rules manager device 108 (FIG. 6). When the client device 118 wishes to purchase the NFT 120, the NFT 120 is transferred from the first owner (“from” account) to the client device 118 (“to” account).

The burning application 310 of the node 112 can be configured to burn a NFT token. The processor 302 can also execute the fusing of two or more original NFTS into a new NFT, which includes minting a new NFT and burning the original NFTs.

The processor 302 can execute a smart contract authenticator 306. The smart contract authenticator 306 authenticates a transfer of the NFT 120 using a smart contract 150 and the blockchain 130.

As with many smart contracts on the blockchain, the smart contract 150 includes both detection and execution. The smart contract 150 can identify the particular condition or trigger of the smart contract 150 and what is to be performed by the node 112 upon successful transfer of the NFT 120. For example, the node 112 may mint a new NFT 120 in response to executing one of the rule 124. In other examples, the execution of the rule 124 can include the node 112 transferring another NFT 120 (an already minted NFT 120) to the client device 118. In other examples, the execution of the rule 124 can include the node 112 transferring a token on the blockchain (newly or already generated) to the client device 118.

For example, the condition for the rule 124 can be in dependence of a relationship between the NFT 120 at issue and another (second) NFT 120 in the set of NFTs. For example, the condition for the rule 124 can be that the NFT 120 and the second NFT 120 are owned by the same client device 118.

In some examples, a single NFT 120 may be divided into fractions, such that the fractions themselves may indicate partial ownership of the NFT 120, and indirectly partial ownership of the item or digital asset represented by the NFT 120. Even though some of the examples refer to NFTs 120 in as single entities, the NFT methods can similarly apply to fractions of NFTs 120 and interrelationships between rules and fractions of NFTs 120 and corresponding triggers of activities defined by the rules 124.

For example, the rule 124 can be that a first fraction of the NFT 120 and a second fraction of the NFT 120 are owned by the same client device 118. For example, the node 112 may mint a new NFT 120 or transfer an NFT 120 in response to executing one rule 124 that the first fraction and the second fraction are commonly owned. Similarly, the rule 124 can be that all of the fractions of an NFT 120 are owned by the same client device 118. In response, the rule 124 can be that a new NFT 120 is minted and transferred to the same client device 118.

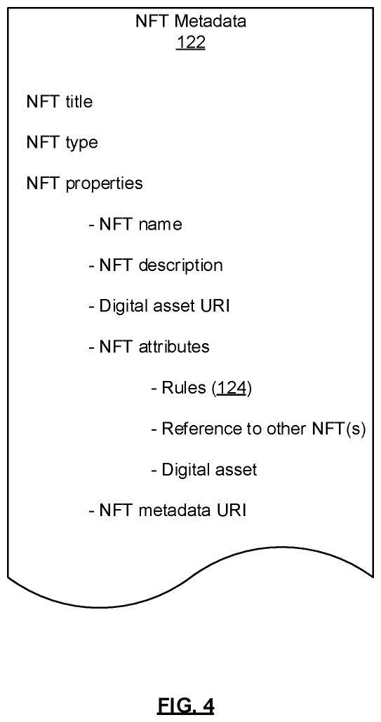

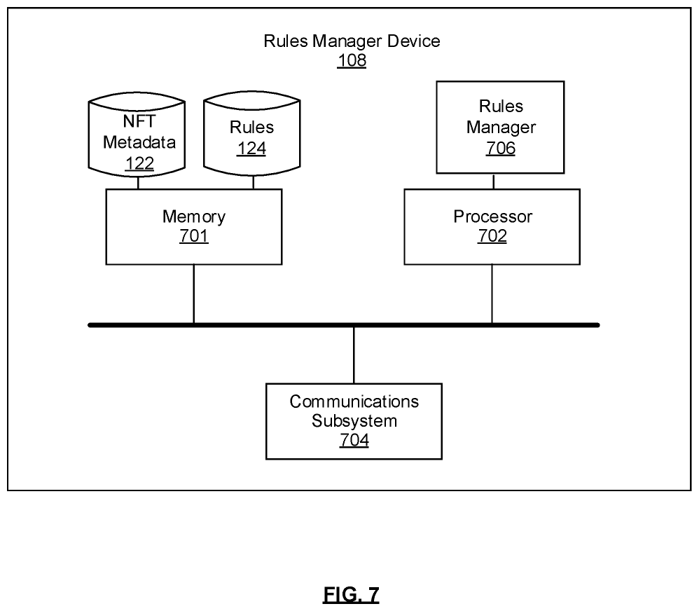

FIG. 4 illustrates a detailed example of NFT metadata 122 for the NFT system of FIG. 1, in accordance with an example embodiment. In an example, there is a respective NFT metadata 122 that is unique to each NFT 120. In an example, some or all of the NFT metadata 122 is stored on the blockchain 122. In an example, some or all of the NFT metadata 122 is stored on the off-chain storage 102, and can addressed using a NFT metadata URI. In an example, some or all of the NFT metadata 122 is stored on the rules manager device 108 (see FIGS. 6 and 7), and can addressed using a NFT metadata URI.

In some examples, the NFT metadata 122 is immutable. In some other examples, the NFT metadata 122 is editable. For example, the NFT metadata 122 may be edited by the node 112, the client device 118, or the rules manager device 108 (see FIGS. 6 and 7). Editing the NFT metadata 122 is compatible with ERC-721 and ERC-1155. For example, the NFT metadata 122 can be edited when the client device 118 owns a particular subset of the set of NFTs 120 (or all of the set of NFTs 120). For example, the NFT metadata 122 can be edited when the client device 118 owns a threshold fraction of one NFT 120, such as a first fraction and a second fraction of the one NFT 120 (or also a third fraction, etc.).

In some examples, the NFT metadata 122 is stored in the smart contract 150. In some examples, the rules 124 include the NFT metadata.

As shown in FIG. 4, the NFT metadata 122 can include one or more of: NFT title, NFT type, and NFT properties. The NFT properties can include: NFT name, NFT description, digital asset URI, NFT attributes, and NFT metadata URI. The NFT attributes can include the rules 124, reference to other NFT(s), and the digital asset itself. The digital asset can be in the NFT metadata 122, for examples a numeric, alphanumeric, or alphabet string. In some examples, the digital asset URI contains an address to the off-chain storage 102 in order to retrieve the digital asset. In some examples, the NFT metadata URI contains an address to the off-chain storage 102 in order to retrieve the NFT metadata 122 off the chain.

In an example scenario, the NFT title is the title of the NFT 120, the NFT type is “object”. The NFT description identifies the digital asset 104 to which this NFT represents. The reference to other NFT(s) can refer to other NFTs in the NFT set. The rules 124 can relate to other NFTs 120 in the NFT set, for example executing the rule 124 when the rule 124 is satisfied. An example of execution of the rule 124 is minting a new NFT 120, for example when the client device 118 owns a particular subset of the NFTs 120 (or all of the NFTs 120 in a set of NFTs). Another example of execution of the rule 124 is transferring an already minted NFT 120 to the client device 118 when the client device 118 owns a particular subset of the NFTs 120 (or all of the NFTs 120 in a set of NFTs). In other examples, the execution of the rule 124 can include the node 112 transferring a token on the blockchain (newly or already generated) to the client device 118.

In an example, the metadata field for the reference to other NFT(s) can, for example, define the set of NTFs 120. For example, each NFT 120 can indicate in the reference to other NFT(s) the name or the blockchain address of at least one or all of the other NFTs 120 in the set. In another example, the first NFT 120 can reference to only the second NFT 120, and the second NFT 120 can only reference to the third NFT 120, and so on in a linked list or linked circle. Such an architecture links all of the NFTs 120 together.

In other examples, there are more or fewer metadata fields in the example NFT metadata 122 illustrated in FIG. 4.

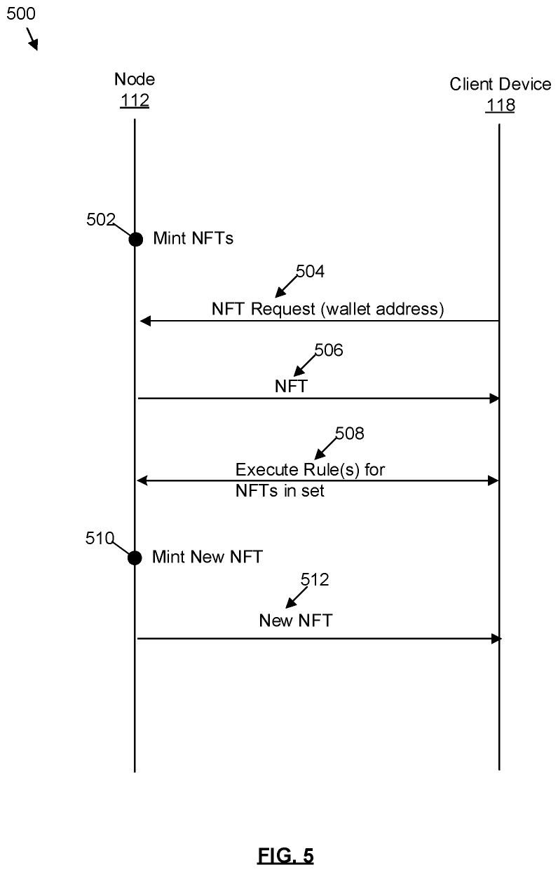

FIG. 5 illustrates a detailed example communication flow diagram of the NFT method 500 between the node 112 and the client device 118, for the system 100 in FIG. 1, in accordance with an example embodiment. At step 502, the node 112 mints one or more NFTs 120. At step 504, the client device 118 requests an NFT 120, and advises of the wallet address of the client device 118. At step 506, the NFT 120 is transferred to the client device 118. In some alternate examples, step 502 is performed after step 504, for example the minting is performed by the node 112 on demand.

The client device 118 now owns the NFT 120. The client device 118 may also own other NFTs 120 in the wallet 210. At step 508, either or both of the node 112 and the client device 118 execute one or more of the rules 124. For example, the client device 118 may present a number of NFTs to prove that the client device 118 owns a defined subset of the NFTs 120 (or all of the NFTs 120 in a set of NFTs). For example, the node 112 verifies the subset of the NFTs 120 or performs aspects of the smart contract 150. For example, the node 112 may automatically perform the smart contract 150 after transferring the NFT 120 to the client device 118.

In an example, at step 510, the node 112 mints a new NFT 120. For example, the node 112 may determine that the client device 118 is the owner of a particular subset of the NFTs 120, and the new NFT 120 represents that the particular subset of the NFTs 120 is owned by the owner. A command such as “ownerOf(tokenId)” from ERC 721 can be used, which uses the blockchain address of the NFT 120 to return the wallet address of the current owner, which can be matched to the wallet address of the client device 118.

In some examples, at step 510 the new NFT 120 was pre-minted or is owned by a different owner, which is then transferred to the client device 118, automatically based on the smart contract 150 or a rule 124. At step 512, the new NFT 120 is transferred to the client device 118 on the blockchain 130. Steps 510 and 512 can be combined in some examples, as is typical in blockchain applications. In some examples, the node 112 or the client device 118 also modifies the NFT metadata 122, for example in the NFT attributes to indicate ownership of the new NFT 120 or one of the other NFTs 120.

In another example of the NFT method 500, the NFT 120 has a plurality of fractions or fractional NFTs. The rule 124 or the smart contract 150 relates to the client device 118 owning more than one fraction of the NFT 120, such as a first fractional NFT and a second fractional NFT of a particular NFT 120. The rest of the NFT method 500 can be implemented in a similar fashion.

FIG. 6 illustrates in diagrammatic form another example NFT system 100 and NFT method, in accordance with another example embodiment. In contrast to FIG. 1, the NFT system 100 in FIG. 6 relates to the processing, steps, and rules of the NFT method being performed by the nodes 112 on the blockchain 130 as well as a rules manager device 108 off the blockchain 130. The client device 118 and the nodes 112 can be the same or similar as those described in relation to FIGS. 2 and 3, respectively.

The rules manager device 108 can perform various management functions for the NFT system 100. In an example, the rules manager device 108 has master control or executes master information in relation to the rules 124 so that all parties and owners know which rules 124 will be executed by the rules manager device 108.

An example embodiment of the NFT method includes at least one node 112 minting or transferring on the blockchain 130 a first NFT 120 having NFT metadata 122. The first NFT 120 is minted or transferred to the client device 118. The NFT method includes executing, using the rules manager device 108, at least one rule 124 which references the first NFT and 120 at least one other NFT 120.

In an example, the executing of the rule 124 includes minting, using at least one node 112, a new NFT 120 on the blockchain 130, and transferring, using the at least one node 112, the new NFT 120 on the blockchain 130 to the client device 118 (which is the same owner as the first NFT 120).

For example, the rule 124 can include the rules manager device 108 determining that the first NFT 120 and the at least one other NFT are commonly owned by the client device 118, and in response to the determining, requesting the node 112 to mint the new NFT 120. The rules manager device 108 can execute other steps of the rule 124 (or smart contract 150).

In an example, the rules manager device 108 can determine the ownership of the first NFT 120 by querying the blockchain 130 to verify that the wallet address of the first NFT 120 matches the wallet address of the client device 118.

In an example, the rule 124 references a respective address on the blockchain 130 of the at least one other NFT 120. In an example, the rule 124 references a respective NFT name of the at least one other NFT 120.

In an example, the rule 124 includes rules manager device 108 determining that the first NFT 120 and the at least one other NFT 120 satisfy a set of NFTs 120. For example, the client device 118 can own a certain subset of the set of NFTs 120 that triggers execution of the rule 124.

The rules manager device 108 can also execute other rules 124 as described herein.

In an example, the rule 124 includes the rules manager device 108 modifying the NFT metadata 122, for example when the NFT metadata 122 is stored on the rules manager device 108. In an example, the NFT metadata 122 is modified to reference at least one of the further NFTs 120 (for example, which are also owned by the client device 118) or modified to reference the new NFT 120 (which is now owned by the client device 118). Similarly, the NFT metadata 112 of the new NFT 120 scan include a reference to the first NFT 120. In another example, the NFT metadata 122 of the first NFT 120 is modified to indicate that a rule 124 is satisfied or was executed.

In an example, the NFT method is continuously and repeatedly performed by the NFT system 100 of FIG. 6. In examples, the NFT method can be performed in parallel by the nodes 112 with other users and their respective client device 118.

FIG. 7 illustrates in diagrammatic form the rules manager device of the NFT system 100 of FIG. 6, in accordance with an example embodiment. In an example, the rules manager device 108 is an off blockchain computing device. For example, rules manager device 108 is responsible for executing activities off the blockchain 130. In an example, the rules manager device 108 is responsible for executing one or more of the rules 124 or one or more of the smart contracts 150. In some examples, the rules manager device 108 is a server or a cloud server.

The rules manager device 108 can include a memory 701, a processor 702, and a communications subsystem 702 which in examples can be similar to those described in relation to the client device 118 (FIG. 2). In some examples, the processor 702 can include a rules manager 706, which can be part of or include a smart contract manager.

In some examples, the memory 701 of the rules manager device 108 stores a copy of the rules 124 and the NFT metadata 122. In some examples, the NFT metadata URI (FIG. 4) addresses the rules manager device 108. In some examples, the NFT metadata 122 is a copy of the same NFT metadata 122 store on the blockchain layer 106. In some examples, the NFT metadata 122 is not stored on the blockchain layer 106 but rather is only stored in the rules manager device 108 (and optionally in the off-chain storage 102).

In some examples, not shown, the rules manager device 108 is also the off-chain storage 102 and therefore the memory 701 stores the digital asset 104, such as an image or digital file.

In various examples, the NFT metadata 122, the rules 124, and the smart contracts 150 are separate. In various examples, the NFT metadata 122, the rules 124, and the smart contracts 150 are combined and/or one include another.

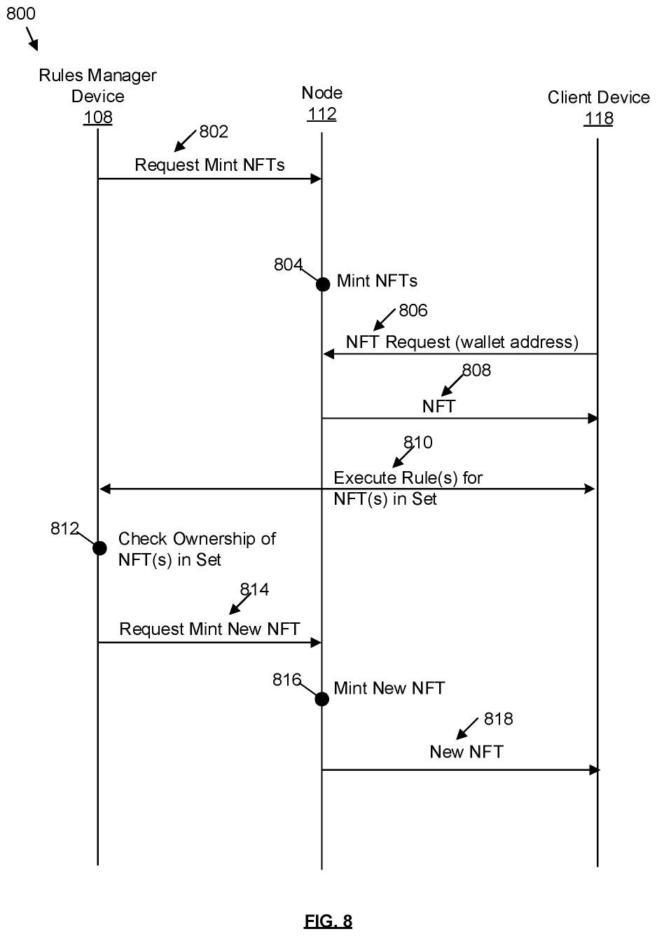

FIG. 8 illustrates a detailed example communication flow diagram of the NFT method 800 between the node 112, the client device 118, and the rules manager device 108, for the system 100 in FIG. 6, in accordance with another example embodiment. For example, the rules manager device 108 is off the blockchain 130. In an example scenario, the rules manager device 108 can store the rules 124, smart contracts 150, and/or the NFT metadata 122. At step 802, the rules manager device 108 requests the node 112 to mint a set of NFTs 120 on the blockchain 130. The rules manager device 108 can set the NFT metadata 122 at this time as well, and instruct the node 112 as to the contents of the NFT metadata 122. At step 804, the node 112 mints the NFTs 120. At step 806, the client device 118 requests an NFT 120 from the node 112, and advises of the wallet address of the client device 118. At step 808, the NFT 120 is transferred to the client device 118. In some alternate examples, step 804 is performed after step 806, for example the minting is performed by the node 112 on demand (with the parameters and NFT metadata 112 as advised by the rules manager device 108 at step 802).

The client device 118 now owns the NFT 120. The client device 118 may also own other NFTs 120 in the wallet 210. At step 810, either or both of the client device 118 and the rules device manager 108 execute one or more of the rules 124. For example, the client device 118 may present a number of NFTs 120 to the rules manager 108 to prove that the client device 118 owns a defined subset of the NFTs 120. For example, at step 812 the rules manager checks the ownership of a particular number of the NFTs 120 in the set of NFTs 120. At step 814, upon satisfaction of the rule 124 that the client device 118 owns a particular subset of the set of NFTs 120, the rules manager device 108 requests the node 112 to mint a new NFT 120 (with the client device in the “to” account). The request at step 814 can include the wallet address of the client device 118. At step 816, the node 112 mints the new NFT 120. At step 818, the new NFT is transferred to the client device 118 on the blockchain 130. Steps 816 and 818 can be combined in some examples, as is typical in blockchain applications.

For example, the rules manager device 108 verifies the subset of the NFTs or performs aspects of the smart contract 150. For example, the rules manager device 108 may automatically perform the smart contract 150 after the node 112 transfers the NFT 120 to the client device 118.

In some examples, referring to step 816, the new NFT 120 was pre-minted or is owned by a different owner, which is then transferred to the client device 118, automatically based on the smart contract 150 or a rule 124. In other examples, the execution of the rule 124 can include the node 112 automatically executing the smart contract 150 or the rule 124 to transfer a token on the blockchain (newly or already generated) to the client device 118.

In some examples, the rules manager device 108 or the client device 118 also modifies the NFT metadata 122, for example in the NFT attributes to indicate ownership of the new NFT 120 or one of the other NFTs 120.

In some examples, the rules manager device 108 continuously polls the blockchain 130 to determine whether any of the rules 124 are satisfied, for example when a client device 118 owns a particular subset of the NFTs 120, or acquired the subset of NFTs 120 in a particular order or at different locations. In such an example, the rules manager device 108 does not need to receive a particular request to mint a new NFT 120 from the client device 118 or the node 112.

In another example of the NFT method 800, the NFT 120 has a plurality of fractions or fractional NFTs. The rule 124 or the smart contract 150 relates to the client device 118 owning more than one fraction of the NFT 120. The rest of the NFT method 800 can be implemented in a similar fashion.

In some alternate examples of the NFT method 800, rather than any or all steps that include NFT minting or transferring, the NFT method instead performs NFT burning or NFT fusing.

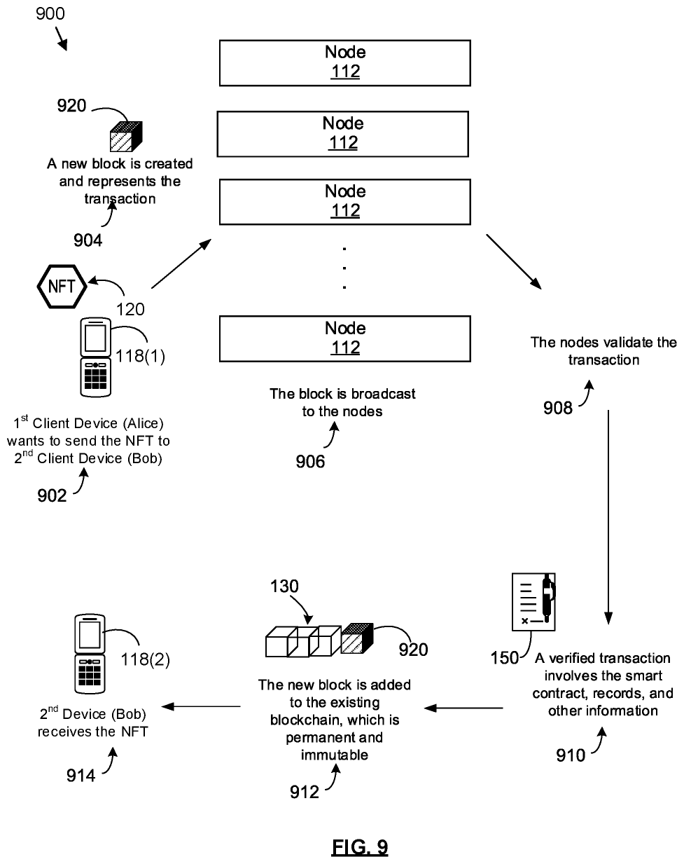

FIG. 9 illustrates a detailed example of a NFT transfer method 900 for transferring a NFT 120 over the blockchain 130, for the NFT method illustrated in any of FIGS. 1 and 6, in accordance with an example embodiment. For example, at step 902, a first device 118(1) (Alice) wishes to transfer the NFT 120 to a second device 118(2) (Bob). The first device 118(1) owns the NFT 120 on the blockchain 130. At step 904, the first device 118(1) initiates a transaction on the blockchain 130, for example using a wallet private key from the wallet 210. At step 904, a new block 920 is created by the first device 118(1) and represents the transaction. At step 906, the new block 920 is broadcast to the nodes 112. At step 908, the nodes 112 validate the transaction on the blockchain 130 (using consensus or other mechanisms). At step 910, a verified transaction involves the smart contract 150, records, and other information. For example, one or more of the rules 124 of the smart contract 150 can be performed by the nodes 112, such as minting a new NFT 120. At step 912, the new block 920 is added to the existing blockchain 130, which is permanent and immutable. At step 914, the second device 118(2) receives the NFT 120 on the blockchain 130, for example by receiving a private key associated with the new blockchain 130 having the new block 920. For example the wallet address of the second device 118(2) is noted on the blockchain 130 as being the owner of the NFT 120.

In another example of the NFT transfer method 900, the NFT 120 has a plurality of fractions or fractional NFTs. The rule 124 or the smart contract 150 relates to the client device 118 owning more than one fraction of the NFT 120. The rest of the NFT transfer method 900 can be implemented in a similar fashion.

In some alternate examples of the NFT method 900, rather than any or all steps that include NFT minting or transferring, the NFT method instead performs NFT burning or NFT fusing.

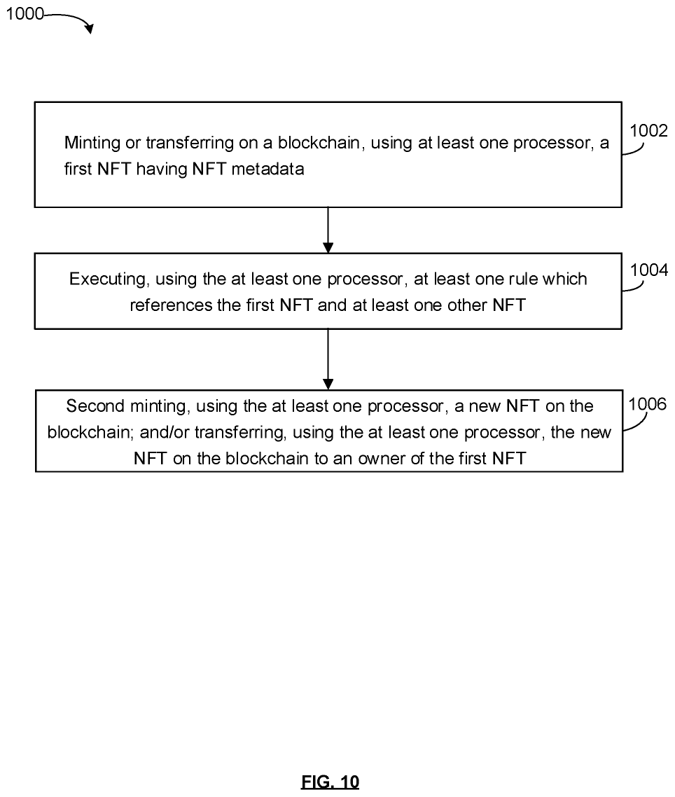

FIG. 10 illustrates another detailed example of the NFT method 1000 as performed by the NFT system 100, in accordance with an example embodiment. At step 1002, one or more of the nodes 112 performing minting or transferring on a blockchain a first NFT 120 having NFT metadata 122. The first NFT 120 is minted or transferred to an owner (client device 118). At step 1002, one or more of the nodes 112 execute at least one rule 124 which references the first NFT 120 and at least one other NFT 120. The at least one rule 124 can be executed by a smart contract 150. The rule can be that a particular client device 118 owns the first NFT 120 and at least one other NFT 120. At step 1006, one or more of the nodes 112 perform second minting of a new NFT 120 on the blockchain, and/or second transfer the new NFT 120 on the blockchain to the owner of the first NFT 120. For example, the new NFT 120 is second minted and/or second transferring is based on the execution of the rule.

In another example, the NFT method includes the nodes 112 minting a first NFT 120 and generating fractions of the NFT 120. The minting includes generating NFT metadata 122 for the NFT. A first fraction of the NFT 120 is transferred to an owner (client device 118). One or more of the nodes 112 execute at least one rule 124 which references the first fraction of the NFT 120 and at least one other fraction of the NFT 120. The at least one rule 124 can be executed by a smart contract 150. The rule can be that a particular client device 118 owns the first fraction of the NFT 120 and at least one other fraction of the NFT 120. In the NFT method, the one or more of the nodes 112 perform second minting of a new NFT 120 on the blockchain, and transfer the new NFT 120 on the blockchain to the owner of the first fraction and the second fraction of the NFT 120.

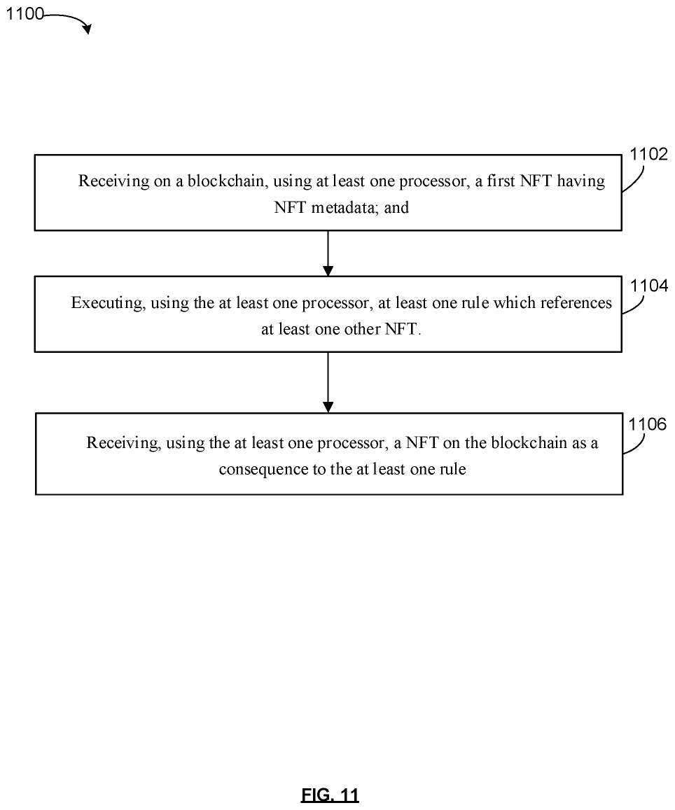

FIG. 11 illustrates another detailed example of the NFT method 1100 as performed by the client device 118, in accordance with an example embodiment. At step 1102, the client device 118 receives on a blockchain a first NFT 120 having NFT metadata 122. At step 1104 the client device 118 executes, at least one rule 124 which references at least one other NFT 120. The at least one rule 124 can be executed by a smart contract 150. For example, the rule 124 can be that the client device 118 owns the first NFT 120 and the at least one other NFT 120. In response, one or more of the nodes 112 can mint a new NFT 120 when the rule 124 is satisfied. At step 1106, the client device 118 receives the newly minted NFT 120 or a previously minted NFT 120 on the blockchain as a consequence to the rule 124.

In some alternate examples of the NFT method 1100, rather than any or all steps that include NFT minting, the NFT method instead performs NFT burning or NFT fusing. For example, at step 1106, rather than minting, the client device 118 receives a newly fused NFT or confirmation that an NFT was burned.

In another example, the NFT method 1100 and the rule 124 includes the client device 118 owning a first fraction of the NFT 120 and a second fraction of the NFT 120. In response, one or more of the nodes 112 can mint a new NFT 120 when the rule 124 is satisfied. The client device 118 receives the newly minted NFT 120 on the blockchain as a consequence to the rule 124.

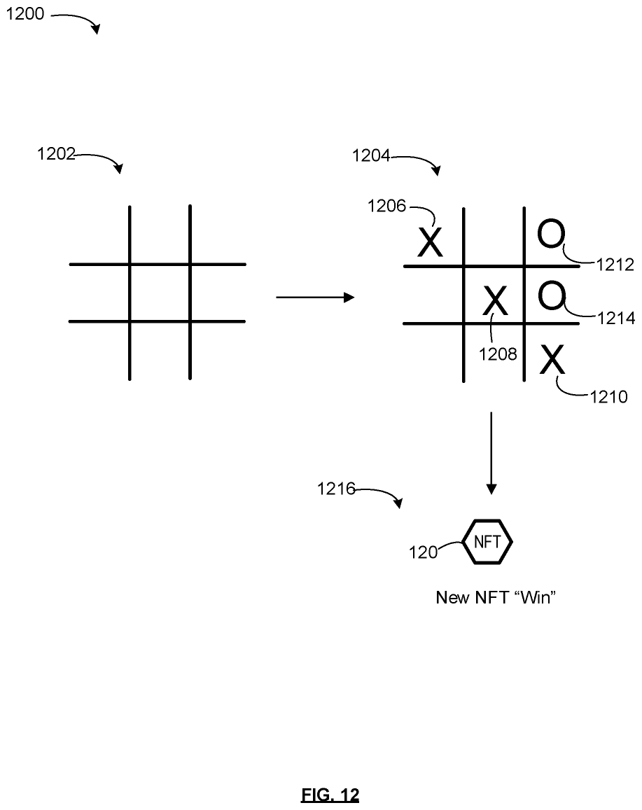

FIG. 12 illustrates an example of the NFT method 1200 as applied to a tic tac toe game. As illustrated at 1202, the game includes a 3×3 grid. Each grid location is a game element. The goal is for one player to have three consecutive grid locations of their game piece (row, column or diagonal). When a player has three consecutive grid locations, that player is indicated as winning the game. In an example of the NFT method 1200, each of the nine grid locations can be an NFT 120 purchased by a user, for example top-left, top-middle, top-right, left, middle, right, bottom-left, bottom-middle, bottom-right. At 1204, one player (client device 118) owns the game elements: top left 1206, middle 1208, and 1210. A second player (client device 118) owns the game elements: top right 1212, right 1214. The first player (client device 118) that owns three NFTs that represent the three consecutive grid locations (row, column or diagonal) is indicated as having won. Based on the smart contract 150, the indication can be made in the NFT metadata 122, e.g., in the rules manager device 108 or on the blockchain layer 106, for example. In an example of the smart contract 150, at 1216, a new NFT 120 can be minted to the player owns three consecutive grid locations of the NFTs 120, which indicates a win condition based on ownership of a subset of the NFTs 120. In other examples, the NFT 120 that indicates the win condition may already be minted or owned by a previous winner (owner), and that NFT 120 is transferred to the present player (winner) who owns the three consecutive grid locations of the NFTs 120. In some examples, a rule 124 (or smart contract 150) is that two players must alternate the purchasing of an NFT 120 (grid location) until one player wins and is minted or transferred the NFT 120 relating to the win condition. Such a rule 124 is similar to the standard rules of tic tac toe, where players take turns in placing their X or O on a grid location. In other examples, any player who owns three consecutive grid locations of the NFTs 120 at any time is minted or transferred the NFT 120 relating to the win condition, without necessarily alternating turns for purchasing.

In another example of the NFT method 1200 as applied to the tic tac toe game, each game element (grid location) is represented by a fraction of an NFT 120. The remainder of the NFT method 1200 would operate in a similar manner.

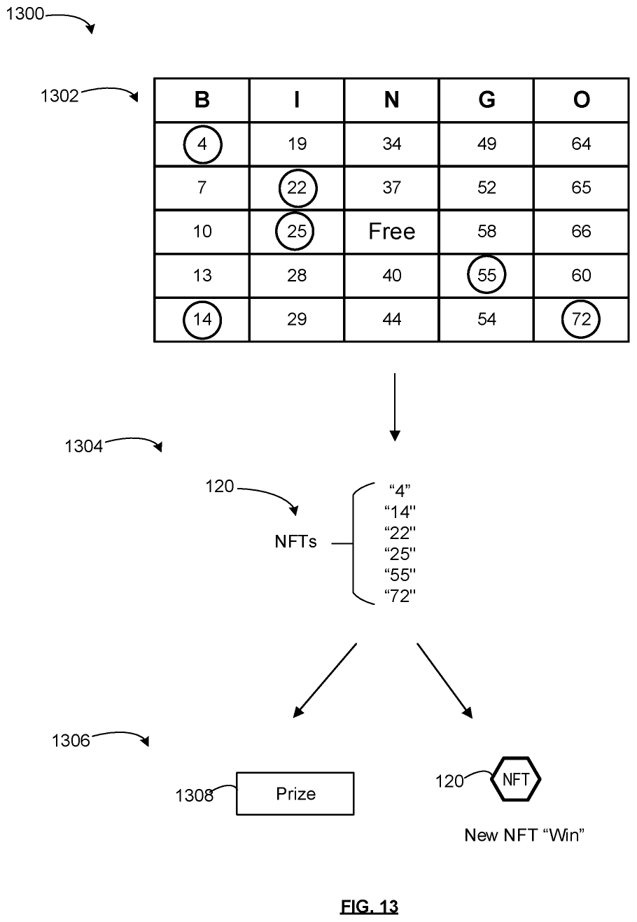

FIG. 13 illustrates an example of the NFT method 1300 as applied to a bingo game. In another example scenario, the set of NFTs 120 relate to the game of bingo. The game includes a 5×5 grid. In some examples, each grid location is a game element. Each number (associated with a letter) is a game element that can be minted and owned as an NFT 120. When a player has five consecutive grid locations (row, column or diagonal), that player is indicated as winning the game.

In other examples, there are other variants of win conditions for the bingo game, such as “four corners”, “whole card”, “cross-shape”, “X-shape”, etc.

In an example of the NFT method 1300, a player can own (purchase) at least one of the 75 numbers (each associated with a letter). At 1302, a particular bingo card can be revealed. If a player owns the numbers on the bingo card that satisfy a particular rule 124 for a win condition, such as five consecutive grid locations, that player is be indicated as having won. In the present example, at step 1304, it is determined that one owner (client device 118) owns NFTs for the numbers “4”, “14”, “22”, “25”, “55”, “72”. As illustrated at 1302 ownership is illustrated by way of circles or other markers, and the client device 118 owns five NFTs corresponding to consecutive grid locations in a diagonal, from top left to bottom right. The middle square is a free square. Based on the smart contract 150, the indication that the client device 118 owns five consecutive grid locations NFTs can be made in the NFT metadata 122 of the rules manager device 108 or on the blockchain layer 106, for example. At 1306, in an example of the smart contract 150, a new NFT 120 can be minted that indicates that the player owns five consecutive grid locations of the NFTs, which indicates that the player has won. In other examples, the NFT 120 that indicates the win condition may already be minted or owned by a previous winner (owner), and that NFT 120 is transferred to the present player (winner) who owns the five consecutive grid locations of the NFTs 120.

The smart contract 150 can also be used to transfer a prize 1308 to the owner. The prize 1308 can be money, a media file, a cryptocurrency, etc. The prize 1308 can be pooled from players in the game. The prize 1308 can be obtained by garnishing from the various NFT transactions related to the bingo game. The prize 1308 can be sponsored by an advertiser.

In an example, if no user owns the particular NFTs 120 to satisfy the win rule in the bingo game, then users can purchase NFTs 120 until the win condition is satisfied. In some other examples, there is no winner until the next bingo card is revealed.

In another example of the NFT method 1300 as applied to the bingo game, each game element (bingo number) is represented by a fraction of an NFT 120. The remainder of the NFT method 1300 would operate in a similar manner.

In an example, the bingo game is reset at periodic intervals or after the prizes are fulfilled. In such an example, all of the NFTs for the bingo game are burned and new NFTs are available for minting and for purchase for the next bingo game. In some examples, the new NFTs are used for a different game or application other than the bingo game.

In another example scenario, the set of NFTs 120 relate to a lottery game. In an example of the lottery game, each lottery number is a game element that can be owned as an NFT 120. In the conventional game, the goal is to match the lottery number to some or all of the drawn numbers. In an example of the NFT method 1300, a player can own (purchase) at least one of the 100 lottery numbers. A particular set of drawn numbers can be revealed, e.g. 10 numbers. If a player owns the lottery numbers that satisfy a particular rule for a win condition, such as all or a set number of the drawn numbers, that player is be indicated as having won that particular win condition. The indication can be made in the NFT metadata 122 of the rules manager device 108 or on the blockchain layer 106, for example. In an example, a new NFT can be minted that indicates that the player owns the particular win condition, for example matching all 10 drawn numbers or a particular subset (e.g. 5 drawn numbers). In other examples, the NFT 120 that indicates the win condition may already be minted or owned by a previous winner (owner), and that NFT 120 is transferred to the present player (winner) who owns the particular subset of the NFTs 120 pertaining to that win condition.

The smart contract 150 can also be used to transfer a prize to the owner. The prize can be money, a media file, a cryptocurrency, etc. The prize can be pooled from players in the game. The prize can be obtained by garnishing from the various NFT transactions related to the lottery game. The prize can be sponsored by an advertiser.

In an example, if no user owns the particular NFTs 120 to satisfy the win rule in the lottery game, then users can purchase NFTs 120 until the win condition is satisfied. In some other examples, there is no winner until the next lottery draw is performed.

In an example, the lottery is reset at periodic intervals or after the prizes are fulfilled. In such an example, all of the NFTs for the lottery are burned and new NFTs are available for minting and for purchase for the next lottery. In some examples, the new NFTs are used for a different game or application other than the lottery game.

In another example of the NFT method as applied to the lottery game, each game element (lottery number) is represented by a fraction of an NFT 120. The remainder of the NFT method would operate in a similar manner.

Some examples of the NFT method may require the client device 118 to make a payment by way of currency or cryptocurrency in order to receive the NFT 120, which can part of the smart contract 150 on the blockchain or can be performed off the blockchain.

When an NFT 120 is sold, one or more of the upstream owners can be compensated. For example, the original owner can be compensated and given a royalty each time the NFT 120 is sold. The compensation can be defined in the smart contract 150 or the rules 124.

In some examples, a part of the royalty or compensation from each transfer of the NFT 120 is stored in a common pot that can be subsequently distributed as a prize 1308 for a particular game. The management and distribution of the prize 1308 can be performed based on the rules of the smart contract 150.

As understood in the art, the various NFT processes for the NFT method may require gas such as Ether (ETH) for execution, which is not described in detail herein.

In the example embodiments, it should be understood that the NFT system 100, the NFT method, and the various devices may be implemented in other manners. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions of the embodiments.

In addition, functional units in the example embodiments may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of example embodiments may be implemented in a form of a software product. The software product is stored in a storage medium, and includes several instructions for instructing a computer device (which may be a personal computer, a server, or a network device) to perform all or some of the steps of the methods described in the example embodiments. The foregoing storage medium includes any medium that can store program code, such as a Universal Serial Bus (USB) flash drive, a removable hard disk, a read-only memory (Read-Only Memory, ROM), a random access memory (Random Access Memory, RAM), a magnetic disk, or an optical disc.

In the described methods or block diagrams, the boxes may represent events, steps, functions, processes, modules, messages, and/or state-based operations, etc. While some of the example embodiments have been described as occurring in a particular order, some of the steps or processes may be performed in a different order provided that the result of the changed order of any given step will not prevent or impair the occurrence of subsequent steps. Furthermore, some of the messages or steps described may be removed or combined in other embodiments, and some of the messages or steps described herein may be separated into a number of sub-messages or sub-steps in other embodiments. Even further, some or all of the steps may be repeated, as necessary. Elements described as methods or steps similarly apply to systems or subcomponents, and vice-versa. Reference to such words as “sending” or “receiving” could be interchanged depending on the perspective of the particular device.

The described embodiments are considered to be illustrative and not restrictive. Example embodiments described as methods would similarly apply to systems or devices, and vice-versa.

The various example embodiments are merely examples and are in no way meant to limit the scope of this disclosure. Variations of the innovations described herein will be apparent to persons of ordinary skill in the art, such variations being within the intended scope. In particular, features from one or more of the example embodiments may be selected to create alternative embodiments comprises of a sub-combination of features which may not be explicitly described. In addition, features from one or more of the described example embodiments may be selected and combined to create alternative example embodiments comprised of a combination of features which may not be explicitly described. Features suitable for such combinations and sub-combinations would be readily apparent to persons skilled in the art upon. The subject matter described herein intends to cover all suitable changes in technology.

1. A method comprising:
minting or transferring on a blockchain, using at least one processor, a first non-fungible token (NFT) having NFT metadata; and
executing, using the at least one processor, at least one rule which references the first NFT and at least one other NFT.

2. The method as claimed in claim 1, wherein the at least one rule is executed from a smart contract.

3. The method as claimed in claim 2, wherein the smart contract is on the blockchain.

4. The method as claimed in claim 2, wherein the smart contract is on the first NFT.

5. The method as claimed in claim 2, wherein the smart contract is on at least one of the other NFTs.

6. The method as claimed in claim 2, wherein the smart contract is on at least one computing device off the blockchain.

7. The method as claimed in claim 1, wherein the executing the at least one rule includes:
second minting, using the at least one processor, a new NFT on the blockchain; and
transferring, using the at least one processor, the new NFT on the blockchain to an owner of the first NFT.

8. The method as claimed in claim 7, wherein the executing including determining that the first NFT and at least one other NFT are commonly owned by the owner, and in response to the determining, performing the second minting.

9. The method as claimed in claim 8, wherein the determining includes querying the blockchain to verify that a wallet address of the first NFT belongs to the owner.

10. The method as claimed in claim 7, wherein the second minting includes fusing the first NFT and the at least one other NFT into the new NFT.

11. The method as claimed in claim 10, wherein the fusing includes burning the first NFT and the at least one other NFT.

12. (canceled)

13. (canceled)

14. (canceled)

15. The method as claimed in claim 7, wherein the second minting includes fusing two or more NTFs other than the first NFT and the at least one other NFT into the new NFT.

16. (canceled)

17. The method as claimed in claim 1, wherein the executing the at least one rule includes transferring, using the at least one processor, a new NFT on the blockchain to an owner of the first NFT.

18. (canceled)

19. (canceled)

20. The method as claimed in claim 1, wherein the executing including determining that the first NFT and the at least one other NFT satisfy a set of NFTs.

21. The method as claimed in claim 1, wherein the executing including determining that the first NFT and the at least one other NFT satisfy location criteria.

22. The method as claimed in claim 1, wherein the executing including determining that the first NFT and the at least one other NFT satisfy sequence criteria.

23. The method as claimed in claim 22, wherein the sequence criteria is a temporal sequence or a location sequence.

24. The method as claimed in claim 1, wherein the executing including determining a hierarchy of the first NFT and the at least one other NFT.

25.-73. (canceled)

74. A non-fungible token (NFT) system comprising:
at least one processor configured to:
mint or transfer on a blockchain a first non-fungible token (NFT) having NFT metadata; and
execute at least one rule which references the first NFT and at least one other NFT.

75. (canceled)

76. (canceled)

77. A non-transitory memory containing instructions which, when executed by one or more processors, cause the one or more processors to:
mint or transfer on a blockchain a first non-fungible token (NFT) having NFT metadata; and
execute at least one rule which references the first NFT and at least one other NFT.
